(19) United States
(12) Patent Application Publication
(10) Pub. No.: US 2016/0189163 A1
(43) Pub. Date: Jun. 30, 2016

(54) LEAD MANAGEMENT LIFE FLOW

(71) Applicant: SugarCRM Inc., Cupertino, CA (US)

(72) Inventors: Ing-Marie Jonsson, Los Gatos, CA (US); Maria Zolotova, Mountain View, CA (US)

(21) Appl. No.: 14/586,661

(22) Filed: Dec. 30, 2014

(51) Int. Cl. G06Q 30/00; G06F 17/30

(52) U.S. Cl. CPC G06Q 30/016; G06F 17/30598

(57) ABSTRACT

Embodiments of the invention provide for lead management life flow. A lead management life flow method includes storing lead records in a database coupled to a CRM system, each record storing an identity of a lead, a telephone number for the lead, and a counter indicating a number of attempts to contact the lead. Each lead record is assigned to one or more lead development representatives registered with the CRM system. Thereafter, a number of attempts to contact the leads by the representatives is periodically tracked and the counter for each lead incremented in response to a failed attempt to contact the lead. Finally, the counter is compared to a pre-determined value. If too many attempts to contact the lead resulting in failure are determined to have transpired based upon the comparison of the counter to the value, the lead is reclassified in the database as a dead prospect.

### BACKGROUND OF THE INVENTION

1. Field of the Invention

The present invention relates to sales pipeline management in a customer relationship management (CRM) application and more particularly to lead processing in a sales pipeline within a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. All sales opportunities arranged along each of the sales steps that make up the sales process represented by the sales pipeline. Thus, a business opportunity is a qualified and validated lead for a potential sale of a product or service.

Lead generation and harvesting into a sales opportunity is a critical aspect of the sales pipeline. Generally, to qualify a lead into a sales opportunity, direct contact between a sales representative and the lead is required. More often than not, the direct contact is performed from within a call center by way of a telephone call to the lead. Depending upon the outcome of the telephone call, the lead can be qualified as a sales opportunity within the CRM system, or the lead can be marked as “dead” and discarded from the list of leads. As a third option, to the extent that contact with the lead becomes delayed, for example due to the unavailability of the lead, the lead can remain a lead so that subsequent contact can be attempted.

Managing the harvesting of leads into sales opportunities and tracking the progress of lead harvesting can be critical in the analysis of a sales pipeline. As it is well understood, a greater number of leads actively contacted by telephone will result in a greater number of sales opportunities. However, within the CRM computing environment, little logic is available to support the management of the lead harvesting process.

### BRIEF SUMMARY OF THE INVENTION

Embodiments of the present invention address deficiencies of the art in respect to lead management and provide a novel and non-obvious method, system and computer program product for lead management life flow. In an embodiment of the invention, a lead management life flow method includes storing a multiplicity of lead records in a database coupled to a CRM system, each lead record storing an identity of a lead, a telephone number for the lead, and a counter indicating a number of attempts to contact the lead. The method additionally includes assigning each lead record to one or more of a multiplicity of lead development representatives registered with the CRM system. Thereafter, a number of attempts by the lead development representatives to contact the leads is periodically tracked and the counter for each lead incremented in response to a failed attempt to contact the lead by an assigned one of the lead development representatives. Finally, the counter is compared to a pre-determined value and, in response to a determination that too many attempts to contact the lead have resulted in failure based upon the comparison of the counter to the value, the lead is reclassified in the database as a dead prospect.

In one aspect of the embodiment, the method also includes storing for each record of a lead for which an attempt is successful, an indication of rating applied by the lead development representative proximate in time to the attempt. As such, a visualization is generated in the CRM system showing a number of successful attempts for each indication of rating. In another aspect of the embodiment, different scripts are stored in the database and each lead is dynamically assigned to one or more of the scripts. In yet another aspect of the embodiment, the visualization references one or more of the scripts utilized in successful attempts for each indication of rating. Finally, in even yet another aspect of the embodiment, for each lead development representative, a listing of leads and corresponding phone numbers to be contacted within a specified time period is displayed in a user interface to the CRM system and the leads of the listing are sorted in accordance with a time zone associated with a geographic location of each of the leads. Moreover, an indication of time remaining to place a telephone call to each of the leads is displayed in the user interface accounting for the specified time period and a time zone of each of the leads.

In another embodiment of the invention, a CRM data processing system is configured for lead management life flow. The system includes a CRM application executing in memory of a host computing system that includes one or more computers each with memory and at least one processor. The system also includes a database coupled to the CRM application, the database storing a multiplicity of lead records each including an identity of a lead, a telephone number for the lead, and a counter indicating a number of attempts to contact the lead. Finally, the system includes a lead management life flow module coupled to the CRM application and executing in the memory of the host computing system.

The module includes program code enabled upon execution to assign each lead record to one or a multiplicity of lead development representatives registered with the CRM application, to periodically track a number of attempts to contact the lead by the lead development representatives and to increment the counter for each lead in response to a failed attempt to contact the lead by an assigned one of the lead development representatives, to compare the counter to a pre-determined value and to respond to a determination that too many attempts to contact the lead resulting in failure based upon the comparison of the counter to the value, by re-classifying the lead in the database as a dead prospect.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for lead management life flow;

FIG. 2 is a schematic illustration of a CRM data processing system configured for lead management life flow; and,

FIG. 3 is a flow chart illustrating a process for lead management life flow.

### DETAILED DESCRIPTION OF THE INVENTION

Embodiments of the invention provide for lead management life flow. In accordance with an embodiment of the invention, different leads can be stored in a database of a CRM data processing system. Different ones of the leads can be assigned to different lead development representatives registered with the CRM data processing system. As such, each lead development representative can be presented with a list of one or more of the leads to which the lead development representative places telephone calls, or otherwise sends messages, so as to convert some or all of the leads into sales opportunities. To that end, each lead can have associated therewith a counter indicating a number of attempts to contact the lead. As such, when a lead is determined in the CRM data processing system to have a counter value that exceeds a pre-determined number, the lead can be re-classified from a lead to dead. Yet further, each lead can have associated therewith a quality of contact rating applied by a corresponding lead development representative assigned thereto. Consequently, a lead report can be generated visualizing a number of attempts to contact leads within a time period and how many of the leads had been associated with a particular rating. In this way, a lead development manager can visualize the progress of lead harvesting.

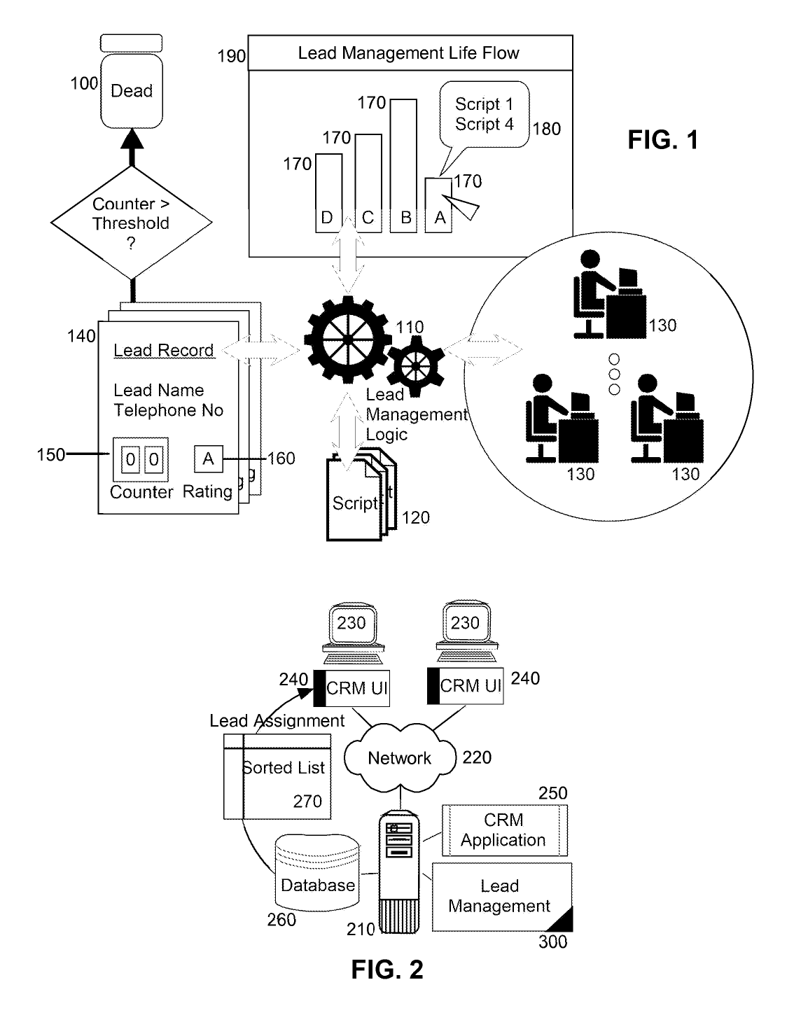

In further illustration, FIG. 1 pictorially shows a process for lead management life flow. As shown in FIG. 1, lead management logic 110 can process different lead records 140 on behalf of different lead development representatives 130 in a CRM application. Each lead record 140 can include a lead name of a lead within a sales lifecycle, a telephone number at which the lead may be contacted, as well as a counter 150 and a rating 160. The counter 150 indicates a number of attempts to contact the lead, such as by way of a telephone call, e-mail message, text message, social media message, to name a few examples, and the rating 160 indicates a subjective quality of an interaction with the lead during the attempt as applied by a corresponding lead development representative. With respect to the former, the lead development logic 110 periodically can inspect the counter 150 for lead record in order to determine if the counter exceeds a pre-set threshold. If so, the lead record can be assigned a dead classification 100.

One or more scripts 120 can be associated with a lead of a lead record 140. Each of the scripts 120 can include a textual dialogue to be presented to a lead upon contacting the lead in a telephone call, or within a message. In the former circumstance, the scripts 120 can be read by the lead development representatives 130 over a telephone call, in the latter instance the content of the scripts 120 can be selectively copied and inserted into messages by the lead development representatives 130. In this regard, each of the scripts 120 can be directed to one or more aspects of a sales campaign for a particular product or service. As such, as a rating 160 is applied to a lead record 140 in connection with an attempt to contact a corresponding lead by one of the lead development representatives 130, one or more of the scripts 120 utilized for that attempt can be identified as having been utilized.

Of note, the lead management logic 110 is enabled to process the lead records 140 in order to group the lead records 140 by rating 160. Optionally, the lead records 140 additionally can be filtered by one or more of the lead development representatives 130 processing the leads of the lead records 140. As such, the lead management logic 110 is enabled to generate a visualization 190 of the lead records 140 according to a grouping 170 of the lead records 140 assigned each rating 160 and optionally as filtered by one or more of the lead development representatives 130. Additionally, one or more of the scripts 120 utilized in attempts to contact the leads of the lead records 140 of each grouping 170 can be presented in a chat script display 180, for instance in response to a mouse-over event detected for a particular one of the groupings 170. In this way, the lead management life flow can be readily visually inspected by a lead development manager for all lead records 140 by one or more of the lead development representatives 130.

The process described in connection with FIG. 1 can be implemented in a CRM data processing system. In yet further illustration, FIG. 2 schematically shows a CRM data processing system configured for lead management life flow. The system can include a host computing system 210 that includes one or more computers, each with memory and at least one processor. The host computing system 219 can support the operation of a CRM application 250 providing CRM functionality to one or more client computers 230 over computer communications network 220 through a CRM user interface 240. The CRM application 250 further can provide access through each CRM user interface 240 to CRM data stored in coupled database 260.

Importantly, a lead management module 300 can be coupled to the CRM application 250. The lead management module 300 includes program code that when executed in the memory of the host computing system 210 is enabled to assign different leads referenced by different lead records in the database 260 to different lead development representatives registered with the CRM application 250. The program code is further enabled to present in a CRM user interface 240 of each different lead development representative a list 270 of one or more of the leads to which the lead development representative places telephone calls or otherwise sends messages so as to convert some or all of the leads into sales opportunities. Optionally, the list 270 can be a sorted list of leads in which the leads are sorted, for example according to time zone of a location of each of the leads, a chosen method of contacting the leads, the existence of a local holiday for selected ones of the leads, the applicability of a particular promotion to selected ones of the leads, or the relationship between inventory and selected ones of the leads.

The program code of the module 300 yet further can be enabled to associate each lead with a counter indicating a number of attempts to contact the lead. Optionally, different counters can be provided for different modes of contacting the lead—such as by way of telephone, e-mail message, instant message, text message or social media message. As such, the program code can be even further enabled to determine when the counter value exceeds a pre-determined number, in response to which the program code is enabled to reclassify the lead as dead. Even yet further, the program code is enabled to assign a quality of contact rating to each lead for which contact is made and as specified by a corresponding lead development representative assigned thereto. Finally, the program code is enabled to generate a lead report visualizing a number of attempts to contact the leads within a time period and how many of the leads had been associated with a particular rating. In this way, a lead development manager can visualize the progress of lead harvesting.

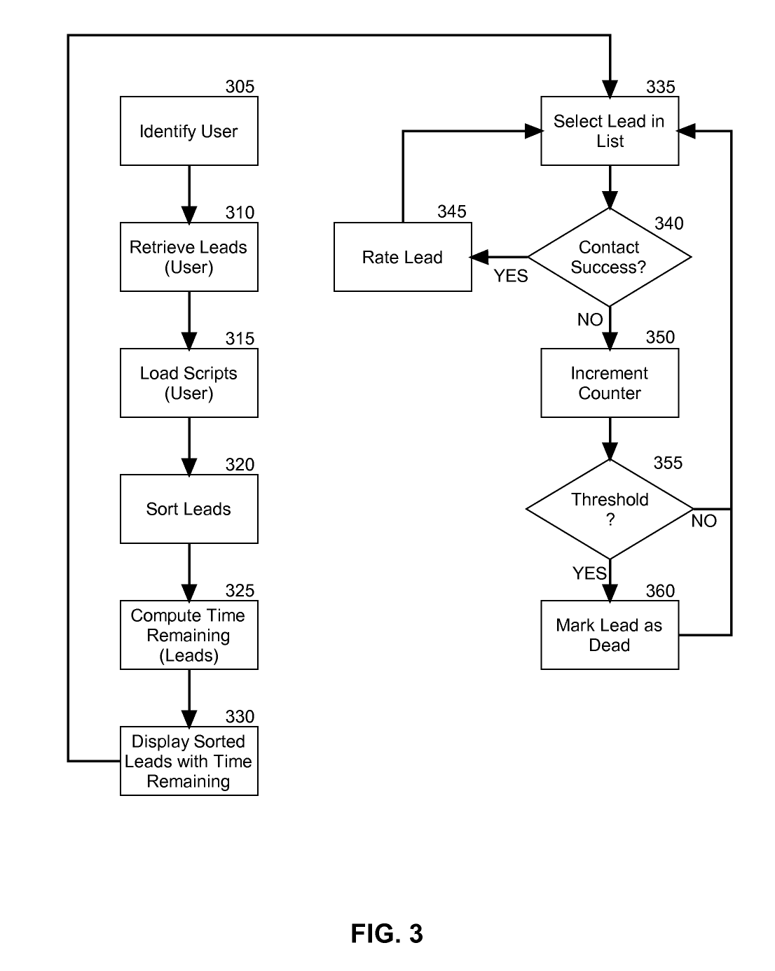

In even yet further illustration of the operation of the lead management module 300, FIG. 3 is a flow chart illustrating a process for lead management life flow. Beginning in block 305, a lead development representative registered in the CRM application can be identified and in block 310, one or more leads encapsulated by respectively different lead records in a database and assigned to the identified lead development representative can be retrieved. In block 315, one or more call scripts accessibly by the identified lead development representative can be loaded and the leads of the lead records can be sorted in accordance with a sorting criteria, for example an associated time zone, a chosen method of contact, an existence of a local holiday, the applicability of a particular promotion, or the relationship with inventory type and levels.

In block 325, based upon a contemporaneous time, a time remaining to contact each lead can be computed for each lead in respect to the contemporaneous time, a set end-of-day time, and any corresponding time zone variance for each lead. Thereafter, in block 330, the sorted list can be displayed in a CRM user interface for the identified lead development representative. Additionally, each lead in the sorted list can be decorated with an indication of a time remaining to contact the lead. Subsequently, in block 335, a lead record in the sorted list can be selected in response to a selection event by the lead development representative. In decision block 340, it can be determined whether or not an attempt to contact a lead of the selected lead record by the lead development representative is successful.

If so, in block 345 a subjectively specified rating as specified by the lead development representative can be stored in the selected lead record. Otherwise, in block 350, a counter in the selected lead record can be incremented and in decision block 355, it can be determined whether or not the counter meets or exceeds a pre-set threshold value. If so, the lead of the lead record can be marked dead. Thereafter, the process can return to block 335 with the selection of another lead record in the sorted list in response to a selection event by the lead development representative.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. In a customer relationship management (CRM) system, a lead management life flow method comprising:
storing a multiplicity of lead records in a database coupled to the CRM system, each lead record comprising an identity of a lead, a telephone number for the lead, and a counter indicating a number of attempts to contact the lead;
assigning each lead record to one or more of a multiplicity of lead development representatives registered with the CRM system;
periodically tracking a number of attempts by the lead development representatives to contact each lead and incrementing the counter for each lead in response to a failed attempt to contact the lead by an assigned one of the lead development representatives;
comparing in the CRM system the counter to a pre-determined value; and,
responsive to a determination that too many attempts to contact the lead have transpired resulting in failure based upon the comparison of the counter to the value, re-classifying the lead in the database as a dead prospect.

2. The method of claim 1, further comprising:
storing for each record of a lead for which an attempt to contact the lead is successful, an indication of rating applied by the lead development representative proximate in time to the attempt; and,
generating a visualization in the CRM system showing a number of successful attempts to contact the lead for each indication of rating.

3. The method of claim 1, further comprising:
storing different scripts in the database; and,
dynamically assigning each lead to one or more of the scripts.

4. The method of claim 2, further comprising:
storing different scripts in the database; and,
dynamically assigning each lead to one or more of the scripts.

5. The method of claim 4, wherein the visualization references one or more of the scripts utilized in successfully attempting to contact leads for each indication of rating.

6. The method of claim 1, further comprising:
displaying in a user interface of the CRM system for each lead development representative, a listing of leads and corresponding phone numbers to be contacted within a specified time period;
sorting the listing of leads in accordance with a time zone associated with a geographic location of each of the leads; and,
displaying in the user interface an indication of time remaining to place a telephone call to each of the leads accounting for the specified time period and a time zone of each of the leads.

7. A customer relationship management (CRM) data processing system configured for lead management life flow, the system comprising:
a CRM application executing in memory of a host computing system comprising one or more computers each with memory and at least one processor;
a database coupled to the CRM application, the database storing a multiplicity of lead records each comprising an identity of a lead, a telephone number for the lead, and a counter indicating a number of attempts to contact the lead; and,
a lead management life flow module coupled to the CRM application and executing in the memory of the host computing system, the module comprising program code enabled upon execution to assign each lead record to one or more of a multiplicity of lead development representatives registered with the CRM application, to periodically track a number of attempts to contact leads by respective ones of the lead development representatives and to increment the counter for each lead in response to a failed attempt to contact the lead by an assigned one of the lead development representatives, to compare the counter to a pre-determined value and to respond to a determination that too many attempts to contact the lead resulting in failure have occurred based upon the comparison of the counter to the value, by re-classifying the lead in the database as a dead prospect.

8. The system of claim 7, wherein the program code is further enabled to:
store in the database for each record of a lead for which an attempt to contact the lead is successful, an indication of rating applied by the lead development representative proximate in time to the attempt; and,
generate in a user interface of the CRM system a visualization showing a number of attempts for each indication of rating.

9. The system of claim 7, wherein the program code is further enabled to:
store in the database different scripts; and,
dynamically assign each lead to one or more of the scripts.

10. The system of claim 8, wherein the program code is further enabled to:
store in the database different scripts; and,
dynamically assign each lead to one or more of the scripts.

11. The system of claim 10, wherein the visualization references one or more of the scripts utilized in successfully attempting to contact leads for each indication of rating.

12. The system of claim 7, wherein the program code is further enabled to:
display in a user interface of the CRM application for each lead development representative, a listing of leads and corresponding phone numbers to be contacted within a specified time period;
sort the listing of leads in accordance with a time zone associated with a geographic location of each of the leads; and,
display in the user interface an indication of time remaining to place a telephone call to each of the leads accounting for the specified time period and a time zone of each of the leads.

13. A computer program product lead management life flow for a customer relationship management (CRM) system, the computer program product comprising a computer readable storage medium having program instructions embodied therewith, the program instructions executable by a device to cause the device to perform a method comprising:
storing a multiplicity of lead records in a database coupled to the CRM system, each lead record comprising an identity of a lead, a telephone number for the lead, and a counter indicating a number of attempts to contact the lead;
assigning each lead record to one or more of a multiplicity of lead development representatives registered with the CRM system;
periodically tracking a number of attempts by the lead development representatives to contact each lead and incrementing the counter for each lead in response to a failed attempt to contact the lead by an assigned one of the lead development representatives;
comparing in the CRM system the counter to a pre-determined value; and,
responsive to a determination that too many attempts to contact the lead resulting in failure have transpired based upon the comparison of the counter to the value, re-classifying the lead in the database as a dead prospect.

14. The computer program product of claim 13, wherein the method further comprises:
storing for each record of a lead for which an attempt to contact the lead is successful, an indication of rating applied by the lead development representative proximate in time to the attempt; and,
generating a visualization in the CRM system showing a number of successful attempts to contact the lead for each indication of rating.

15. The computer program product of claim 13, wherein the method further comprises:
storing different scripts in the database; and,
dynamically assigning each lead to one or more of the scripts.

16. The computer program product of claim 14, wherein the method further comprises:
storing different scripts in the database; and,
dynamically assigning each lead to one or more of the scripts.

17. The computer program product of claim 16, wherein the visualization references one or more of the scripts utilized in successfully attempting to contact leads placed for each indication of rating.

18. The computer program product of claim 13, wherein the method further comprises:
displaying in a user interface of the CRM system for each lead development representative, a listing of leads and corresponding phone numbers to be contacted within a specified time period;
sorting the listing of leads in accordance with a time zone associated with a geographic location of each of the leads; and,
displaying in the user interface an indication of time remaining to place a telephone call to each of the leads accounting for the specified time period and a time zone of each of the leads.
